(19) United States
(12) Patent Application Publication
(10) Pub. No.: US 2006/0011790 A1
(43) Pub. Date: Jan. 19, 2006

(54) Device for the reception of a portable computer, including notebooks and laptops

(76) Inventor: Bernd Lenz, Hannover (DE)

Correspondence Address: SHLESINGER, ARKWRIGHT & GARVEY LLP, 1420 KING STREET, SUITE 600, ALEXANDRIA, VA, 22314, US

(21) Appl. No.: 11/180,684

(22) Filed: Jul. 14, 2005

(30) Foreign Application Priority Data
Jul. 14, 2004 (DE) 10 2004 033 911.2

(51) Int. Cl. F16M 11/04

(52) U.S. Cl. 248/176.3

(57) ABSTRACT

Device for reception of a portable computer, notebook, laptop, and the like, especially for working in a standing position. Device includes a foot portion, a column fixed to the foot portion and at least one supporting arm projecting laterally from the column, at which a desk top for the reception of the computer is arranged. The inclination and distance of the computer relative to the column is adjustable. The foot portion may include at least three horizontally disposed detachably interconnected arms. The column is detachably connected to the foot portion and at least one of the supporting arms is detachably and, for the adjustment of the desktop's inclination, rotatably fastened to the column. The foot portion is provided with castors. The device is engineered to be mobile, and easy to assemble and disassemble for being compactly folded up, transported, space-savingly stored and stowed away.

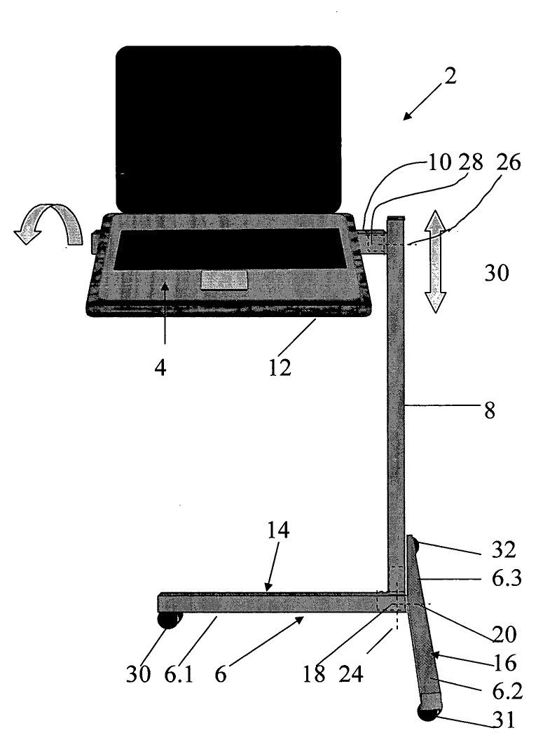

### CROSS-REFERENCE TO RELATED APPLICATIONS

This application claims the priority of German application no. 10 2004 033 911.2, filed Jul. 14, 2004, which is incorporated herein by reference.

### FIELD OF THE INVENTION

The invention relates to a device for the reception of a portable computer (notebook, laptop), especially for working in the standing or seated position. More particularly, the invention relates to a device for the reception of a portable computer that may include a foot portion, a column fixed to the foot portion, at least one supporting arm attached to the column and a reception for the notebook attached to the supporting arm.

### BACKGROUND OF THE INVENTION

A mobile computer and reading station having a lockable base carriage provided with a vertically adjustable detachable and re-attachable standpipe, at the upper end of which a swivel arm is arranged sticking out radially, to which a board is attached for receiving the computer, the inclination and distance of which to the stand pipe is adjustable, is known from DE 203 17 193 U1. Further, another board, serving as a mouse tray, is arranged at the stand pipe below the board for the computer, which is also adjustable in its height, inclination and distance to the stand pipe. The design of this known computer and reading station is complicated and comparatively expensive. Due to the base carriage, the range of applications is restricted. It is not possible to fold the device together to a compact unit which can be easily transported, for example by means of a bag.

A computer standing desk consisting of a lattice frame made of rectangular steel profiles is known from DE 297 04 424. Bases for a computer, a printer, a keyboard and a mouse are arranged on the lattice frame. The design of this known computer standing desk is bulky and it cannot be compactly folded together. Its range of applications is restricted.

DE 697 24 309 T2 discloses a support for portable computers consisting of a rectangular base frame and a frame which can be adjusted in its inclination, with a board for receiving the computer which is arranged at the base frame. This support is designed and also only suited to be used on a table or the like.

An object of the present invention is to develop a device of the aforementioned type in such a way that the manufacture and use are simplified and a variety of applications are provided. Further, for the storage and transport, it shall be possible to fold the device compactly together and it shall be easy to reassemble.

This object is solved by the invention according to claim 1.

Advantageous and purposeful developments of the invention are given below.

The device according to the invention may include only a few detachably interconnected parts, especially rectangular hollow metal profiles, particularly aluminum or steel profiles. The device according to the invention is engineered to be mobile, easy to disassemble and reassemble. In its disassembled state, it can be folded together extremely compactly, easily transported, stored and stowed away space-savingly and is therefore excellently suited for applications at varying places. Due to the vertical adjustment, the device according to the invention can be used as a desk to work at the computer in the standing position, but also in the seated or lying position.

Relative terms such as left, right, up, and down are for convenience only and are not intended to be limiting.

### BRIEF DESCRIPTION OF THE BRIEF DRAWINGS

The invention shall be explained in more detail by way of the attached drawing, which shows an embodiment of the invention.

### DETAILED DESCRIPTION OF THE DRAWINGS

The drawing shows a device 2 for the accommodation of a portable computer (notebook, laptop) 4—hereinafter referred to as notebook, which may include a foot portion 6, a column 8 fixed to the foot portion, at least one supporting arm 10 attached to the column 8 and a reception 12 for the notebook attached to the supporting arm.

The foot portion 6 may include at least three horizontally disposed, detachably interconnected arms 6.1, 6.2, 6.3. The column 8 is detachably connected to the foot portion 6.

The at least one supporting arm 10 is mounted detachably and, for the adjustment of the inclination of the reception 12, rotatably around the longitudinal axis on the column 8. The reception for the notebook may include a board, which is preferably firmly arranged at the supporting arm.

The arms 6.1, 6.2 and 6.3 of the foot portion 6, the column 8 and the at least one supporting arm 10 may be preferably hollow profiles made of aluminum or steel.

The foot portion 6 may include two rectangular hollow profiles, which are detachably interconnected in a T-shaped manner. A component 18 (plotted with a dotted line) inserted into the end of the T-crosspiece serves to connect the T-crosspiece 14 and the T-crossbeam 16, which can be connected to the T-crossbeam 16 with the aid of a connector, for example two screws 20, one of which is plotted with a dotted line.

In order to connect the column 8 to the foot portion 6, especially to the end of the T-crosspiece 14 facing the T-crossbeam 16, a component 22 (plotted with a dotted line) inserted into the lower end of the column is used, to which the foot portion, especially the T-crosspiece of the foot portion can be connected with the aid of a connector, for example two screws 24, one of which is plotted with a dotted line.

The profiles of the foot portion one the one hand, as well as the column and the foot portion on the other hand, are each interconnected in a non-rotatable manner. A component 28 (plotted with a dotted line) is inserted into the end 26 of the supporting arm 10 facing the column 8, by means of which the supporting arm can be connected rotatably around its longitudinal axis to the column 8. A screw 30 (plotted with a dotted line) serves as connection.

The components 18, 22 and 28 inserted into the profiles are preferably solid metal parts, which have an outer contour formed complementarily to the inner contour of the rectangular hollow profiles, and tapped holes for the assembly screws and are fixed into the profiles.

The column 8 may include a height adjustment of at least two hollow profiles located telescopically into one another, displaceable relatively to each other. The column's height is stepwise or continuously adjustable.

In order to ensure a secure support of the notebook, the board of the reception 12 has an element for fixing the notebook.

The foot portion 6 is preferably provided with castors 30, 31, 32, which are preferably located at the free ends of the T-crosspiece 14 and the T-crossbeam 16.

Further receptions or configured reception portions, for example, for a mousepad, for pencils, beakers etc. (not shown), may be located at the column 8.

Other connecting devices or connectors may be used instead of the mentioned screw connection. Thus, the column 8 and the supporting arm 10 on the one hand, and the two parts 14 and 16 of the foot portion on the other hand, may be connected each by means of plug connections with releasable catch, whereby the assembly and disassembly of the device 2 may be carried out even faster.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. Device for the reception of a portable computer, the device being configured for a user working in a standing position, comprising:
a) a foot portion;
b) a column attached to the foot portion;
c) at least one supporting arm projecting laterally from the column;
d) a desk top, the desk top being configured for the reception of the computer, and the desk top being disposed on the supporting arm;
e) the inclination and distance of the desk top relative to the column being adjustable;
f) the foot portion including at least three horizontally arranged detachably interconnected arms;
g) the column being detachably connected to the foot portion; and
h) at least one of the supporting arms being detachably and, for the adjustment of the desk top's inclination, rotatably affixed to the column.

2. Device according to claim 1, wherein:
a) the arms of the foot portion, the column, and at least one of the supporting arms include rectangular hollow profiles made of one of aluminium and steel.

3. Device according to claim 2, wherein:
a) the rectangular hollow profiles include one of metal and plastic material.

4. Device according to claim 3, wherein:
a) the metal is one of aluminium, an aluminium alloy, and steel.

5. Device according to claim 1, wherein:
a) the foot portion includes two rectangular hollow profiles, which are detachably interconnected in a T-shaped manner.

6. Device according to claim 5, wherein:
a) for connecting a T-crosspiece to the T-crossbeam a component, which is firmly inserted into the end of the T-crosspiece, is used, to which the T-crossbeam can be connected with the aid of a connector.

7. Device according to claim 6, wherein:
a) for connecting the column to the foot portion, and to the end of the T-crosspiece facing the crossbeam, a component firmly inserted into the lower end of the column is used, to which the foot portion, at the end of the T-crosspiece facing the T-crossbeam, can be connected with the aid of a connector.

8. Device according to claim 1, wherein:
a) a component is firmly inserted into the end of the supporting arm facing the column by which the supporting arm, being rotatable around the longitudinal axis, can be connected to the column.

9. Device according to claim 1, wherein:
a) profiles of the foot portion on the one hand, as well as the column and the foot portion on the other hand, each are interconnected in a non-rotatable manner.

10. Device according to claim 8, wherein:
a) the components are solid parts, the outer contour of which is formed complementarily to the inner contour of the rectangular hollow profiles.

11. Device according to claim 10, wherein:
a) the solid parts are made of one of metal and plastic material.

12. Device according to claim 1, wherein:
a) a plug connector with releasable catch is used for connecting the column with the supporting arm and with the foot portion s well as for interconnecting the two parts of the foot portion.

13. Device according to claim 1, wherein:
a) the column includes at least two hollow profiles located telescopically in one another.

14. Device according to claim 12, wherein:
a) the column's height can be adjusted stepwise.

15. Device according to claim 12, wherein:
a) the column's height can be adjusted continuously.

16. Device according to claim 1, wherein:
a) the desk top for accommodating the computer has an element for fixing the computer.

17. Device according to claim 1, wherein:
a) the foot portion is provided with casters.

18. Device according to claim 16, wherein:
a) the casters can be one of arrested and locked in position.

19. Device according to claim 1, wherein:
a) further supporting arms with receptive portions for a mousepad, writing utensils, and other utensils, are attachable to the column.
